(19) United States
(12) Patent Application Publication
(10) Pub. No.: US 2014/0162156 A1
(43) Pub. Date: Jun. 12, 2014

(54) ON-BOARD ELECTRICITY PRODUCTION SYSTEM USING A FUEL CELL

(71) Applicants: Herakles, Le Haillan (FR); SNECMA, Paris (FR)

(72) Inventors: Fabien BOUDJEMAA, Garches (FR); Pierre YVART, Ballancourt Sur Essonne (FR); Philippe GAUTIER, Le Plessis Pate (FR); Pierre Guy AMAND, Paris (FR)

(73) Assignees: Herakles, Le Haillan (FR); SNECMA, Paris (FR)

(21) Appl. No.: 14/100,428

(22) Filed: Dec. 9, 2013

(30) Foreign Application Priority Data
Dec. 10, 2012 (FR) 12 61819

(51) Int. Cl. H01M 8/06

(52) U.S. Cl. CPC H01M 8/0606
USPC 429/426

(57) ABSTRACT

The invention relates to an electricity production system for feeding electrical energy to a device of an aircraft. The system comprises a generator for generating gaseous hydrogen from hydrogen in non-gaseous form, a main tank connected upstream to the generator and for containing gaseous hydrogen under a pressure substantially higher than atmospheric pressure, the gaseous hydrogen being produced by the generator, at least one fuel cell, an expander connected upstream to the main tank and downstream to the fuel cell(s), where upstream and downstream are defined relative to the flow direction of the hydrogen under normal conditions of operation of the system, and a control device that regulates the flow rate and the pressure of the gaseous hydrogen from the main tank to the fuel cell(s) via the expander.

### FIELD OF THE INVENTION

The present invention relates to an electricity production system for feeding electrical energy to a device of an aircraft.

### BACKGROUND OF THE INVENTION

In certain situations, one or more devices of an aircraft (e.g. an airplane or a helicopter) need(s) to be capable of being powered electrically by an electricity production system that is independent both of the engine(s) propelling the aircraft and of the auxiliary power unit (APU). Such situations include, for example, an emergency situation in which there is a failure in the operation of an engine or of the APU. In other situations, it is desired to supply additional electricity over and above that supplied by the APU, e.g. while landing.

Energy production systems are known for producing energy in an emergency situation.

For example, there is an electricity production system in which the electricity is generated by a propeller that is deployed while the system is in use. One such “Ram Air Turbine” is described in the introduction of patent EP 1 859 499.

Nevertheless, a Ram Air Turbine is an assembly that is heavy and complex and thus expensive. In addition, its effectiveness depends on the flight configuration of the airplane, and as a result the assembly is not very reliable.

In order to mitigate those drawbacks, a system has been developed that makes use of a fuel cell.

That system comprises a fuel cell, a tank of gaseous hydrogen and a tank of gaseous oxygen for feeding hydrogen and oxygen directly to the fuel cell, and a control device that controls hydrogen and oxygen feeds. Such a system using a fuel cell is described in patent EP 1 859 499.

That system using a fuel cell enables electricity to be delivered quickly regardless of the flight configuration of the aircraft. In addition, it does not have any moving parts, unlike the Ram Air Turbine, and is therefore more reliable.

Nevertheless, that system presents drawbacks.

The system involves using tanks of hydrogen and oxygen, which tanks are heavy. The system therefore weighs down the aircraft, thereby leading to additional fuel consumption by the aircraft. Furthermore, the logistics for filling and calibrating such tanks are complex.

### OBJECT AND SUMMARY OF THE INVENTION

The present invention seeks to remedy those drawbacks.

The invention seeks to propose an electricity production system that is less heavy, and that is suitable for supplying electricity reliably and in all flight configurations of the aircraft.

This object is achieved by the system comprising a generator for generating gaseous hydrogen from hydrogen in non-gaseous form, a main tank connected upstream to the generator and for containing gaseous hydrogen under a pressure substantially higher than atmospheric pressure, the gaseous hydrogen being produced by the generator, at least one fuel cell, an expander connected upstream to the main tank and downstream to the fuel cell(s), where upstream and downstream are defined relative to the flow direction of the hydrogen under normal conditions of operation of the system, and a control device that regulates the flow rate and the pressure of the gaseous hydrogen from the main tank to the fuel cell(s) via the expander.

By means of these provisions, the fuel cell(s) is/are fed more reliably. The expander serves to adjust the pressure and the flow rate of the hydrogen supplied to the cell(s), with this adjustment being performed by the control device. The system is lighter in weight since the hydrogen is in non-gaseous form, thereby making it possible to omit a tank for containing gaseous hydrogen under pressure, where such a tank is heavy and bulky.

Advantageously, the system presents a secondary tank interposed between the main tank and the at least one fuel cell, being connected upstream to the main tank and being connected downstream to the fuel cell(s) via the expander.

Thus, with the secondary tank full of gaseous hydrogen H₂, it is possible to supply hydrogen to the fuel cell(s) more quickly than would be possible if the gaseous hydrogen needed to be produced from the non-gaseous hydrogen contained in the generator.

### BRIEF DESCRIPTION OF THE DRAWINGS

The invention can be well understood and its advantages appear better on reading the following detailed description of an embodiment shown by way of non-limiting example. The description refers to the accompanying drawings, in which:

FIG. 1 is a diagrammatic representation of a system of the invention for producing electrical energy;

FIG. 2 is a diagrammatic representation of a variant of a system of the invention for producing electrical energy; and

FIG. 3 is a diagrammatic representation of another embodiment of a system of the invention for producing electrical energy.

### DETAILED DESCRIPTION

In the description below, the terms “upstream” and “downstream” are defined relative to the flow direction of hydrogen under normal conditions of operation in the electricity production system.

The electricity production system of the invention is on board an aircraft. The aircraft may be an airplane or a helicopter, for example.

The system comprises a generator 10 for generating gaseous hydrogen (H₂) from hydrogen in non-gaseous form.

The generator 10 for generating hydrogen in non-gaseous form presents the advantage of avoiding the use of a tank prefilled with gaseous hydrogen as a source of gaseous hydrogen. Such a tank is heavy and bulky. In addition, maintenance of such a gaseous hydrogen tank requires the use of a filling and calibration system, where such a system is complex.

Since the hydrogen is in non-gaseous form, it may for example be in solid form. By way of example, the hydrogen is present in the form of a solid chemical compound containing one or more atoms of hydrogen, the compound being suitable for releasing hydrogen in gaseous form.

For example, the compound may be a mixture of BH₃NH₃ and Sr(NO₃)₂, which produces gaseous hydrogen H₂ by pyrolysis.

Alternatively, the hydrogen may be in liquid form, e.g. in the form of a liquid chemical compound containing one or more atoms of hydrogen.

The electricity production system of the invention also has a main tank 30 that is connected upstream to the generator 10 and that is for containing the gaseous hydrogen H₂ as generated by the generator 10. The gaseous hydrogen H₂ is stored in the main tank 30. Before the system is put into normal operation for the purpose of feeding the fuel cell (see below), the gaseous hydrogen H₂ in the main tank 30 is at a pressure that is substantially higher than atmospheric pressure.

The term “substantially higher” is used to mean a pressure that is at least five times ambient atmospheric pressure.

When the generator 10 produces not only gaseous hydrogen H₂, but also impurities, e.g. gases, the system advantageously includes a filter 20 that is situated immediately downstream from the generator 10 and upstream from the main tank 30. All of the elements produced by the generator 10 pass through the filter 20. The filter 20 is suitable for filtering the elements produced by the generator 10 so as to pass only gaseous hydrogen H₂, such that only gaseous hydrogen H₂ penetrates into the main tank 30.

The electricity production system of the invention also has at least one fuel cell 50, which cell is fed with gaseous hydrogen H₂ by the main tank 30.

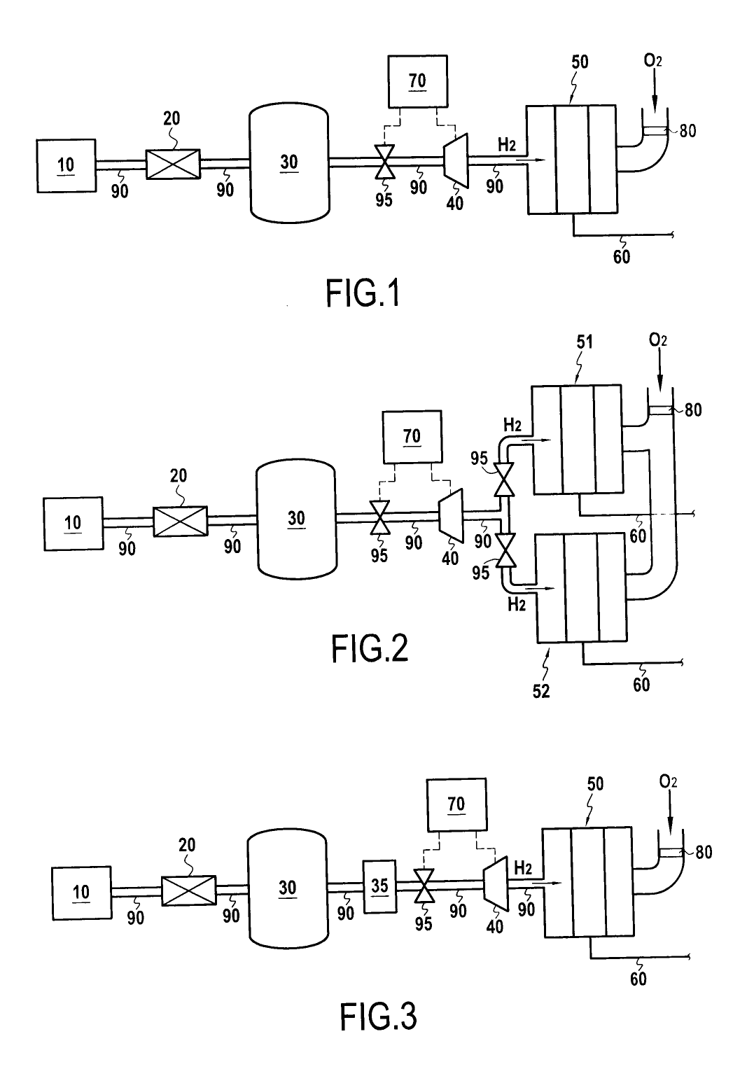

The above-described system is shown in FIG. 1 for the situation in which the system has only one fuel cell 50.

Advantageously, the system of the invention has at least two fuel cells. Such a system is shown in FIG. 2 for a system that has two cells: a first cell 51; and a second cell 52.

Thus, in the event of the first cell 51 failing, the second cell 52 can be used, and the system of the invention remains functional.

The electricity produced by the fuel cell(s) 50 at the terminals of the cell is conveyed by an electric cable 60 to device(s) of the aircraft requiring an electrical power supply.

The electricity production system of the invention also has an expander 40 that is connected upstream to the main tank 30 and downstream to the fuel cell(s) 50.

The gas leaving the main tank 30 thus passes through the expander 40. The expander 40 expands the gaseous hydrogen H₂ and brings the gaseous hydrogen H₂ down to atmospheric pressure before the hydrogen is fed to the fuel cell(s) 50.

In the system of the invention, the gaseous hydrogen H₂ flows between the generator 10 and the fuel cell(s) 50 via channels 90, each channel 90 interconnecting two elements of the system (generator 10, filter 20, main tank 30, secondary tank 35 (see below), expander 40, fuel cell(s) 50).

Advantageously, at least some of the channels 90 include valves 95 (where such a valve is shown in each of the figures) serving to stop (valve in the closed position) or to allow (valve in the open position) gas to flow along the channel 90 in which the valve is situated.

In the absence of an expander 40, i.e. if the channel 90 between the main tank 30 (or the secondary tank 35, see below) and the fuel cell(s) 50 did not contain a valve, the gaseous hydrogen H₂ would reach the fuel cell(s) 50 at a pressure that is too high for optimum operation of the fuel cell(s) 50.

The electricity production system of the invention also has a control device 70 that regulates the flow rate and the pressure of gaseous hydrogen from the main tank 30 to the fuel cell(s) 50 via the expander 40.

Thus, the control device 70 actuates the expander 40 so as to regulate the flow rate and the pressure of the gaseous hydrogen H₂ on arrival at the fuel cell(s) 50.

The control device 70 also actuates the valves 95.

When the system of the invention has at least two fuel cells (e.g. a first cell 51 and a second cell 52), the control device 70 is configured to feed gaseous hydrogen H₂ to each of the fuel cells in alternation, in the event of one of the cells failing. A valve 95 is situated in each of the channels 90 feeding the first cell 51 and feeding the second cell 52, as shown in FIG. 2.

Advantageously, the control device 70 is also configured to feed each of the fuel cells simultaneously, so as to make it possible to deliver greater electrical power.

Advantageously, the system of the invention has a fan 80. The fan 80 serves to improve the efficiency of the fuel cell(s) 50 by making it easier to feed the fuel cell(s) 50 with air, and thus with oxygen.

Advantageously, the fan is connected directly to the fuel cell(s) 50 in order to operate as soon as the fuel cell(s) 50 generate(s) electricity.

Advantageously, the system of the invention has a battery that enables the control device to be kept on standby and that electrically powers the valves and the fan.

The system of the invention is suitable for being tested prior to use in order to verify that it is operating correctly.

In normal operation, the fuel cell(s) 50 is fed with gaseous hydrogen H₂ by the main tank 30 which has previously been filled with gaseous hydrogen H₂ from the generator 10. The cell(s) is/are thus suitable for delivering electricity on demand, e.g. for the functions performed by the APU. If the main tank 30 contains sufficient gaseous hydrogen H₂, there is no need to start the generator 10.

In emergency operation, the generator 10 is activated so as to deliver the quantity of gaseous hydrogen H₂ that is necessary for feeding the fuel cell(s) 50 in order to enable it/them to operate for a determined duration. By way of example, this duration is predefined and the control device 70 starts the generator 10 and causes the generator 10 and the other elements of the system of the invention (in particular the expander 40) to operate in such a manner that the fuel cell(s) 50 operate(s) (i.e. produce(s) electricity) for this predefined duration.

Advantageously, the system of the invention has a secondary tank 35 interposed between the main tank and the fuel cell(s) 50, being connected upstream to the main tank and downstream to the fuel cell(s) 50 via the expander 40. Hydrogen from this secondary tank 35 is thus necessarily fed to the fuel cell(s) 50 via the expander 40.

Such a system having a secondary tank 35 is shown in FIG. 3.

After each use of the system of the invention, the secondary tank 35 remains partially or completely full of gaseous hydrogen H₂ that comes from the main tank 30. The secondary tank 35 ensures that gaseous hydrogen H₂ is always available for feeding to the fuel cell(s) 50, and thus ensures that the response time for feeding the fuel cell(s) 50 is shorter.

Thus, the time interval between the control signal 70 sending a signal to start the system of the invention and electricity being produced by the fuel cell(s) 50 is shorter than it would be if the system did not have a secondary tank 35. In the absence of this secondary tank 35, it might be necessary to start the generator 10 in order to produce gaseous hydrogen H₂ if the quantity of gaseous hydrogen H₂ remaining in the main tank 30 is not sufficient to feed the fuel cell(s) 50. It takes a certain amount of time to start the generator 10 and to produce gaseous hydrogen H₂, and that would delay feeding the fuel cell(s) 50.

Advantageously, the fuel cell(s) 50 is a high temperature proton exchange membrane fuel cell (PEMFC).

The term “high temperature” means a temperature of not less than 120° C.

Advantageously, this temperature lies in the range 160° C. to 180° C.

A high temperature PEMFC presents the advantage of being less sensitive to pollution (such as NH₃, CO) than is a fuel cell operating at a lower temperature.

What is claimed is:

1. An electricity production system for feeding electrical energy to a device of an aircraft, wherein the system comprises a generator for generating gaseous hydrogen from hydrogen in non-gaseous form, a main tank connected upstream to said generator and for containing gaseous hydrogen under a pressure substantially higher than atmospheric pressure, the gaseous hydrogen being produced by said generator, at least one fuel cell, an expander connected upstream to said main tank and downstream to said at least one fuel cell, where upstream and downstream are defined relative to the flow direction of the hydrogen under normal conditions of operation of said system, a control device that regulates the flow rate and the pressure of the gaseous hydrogen from said main tank to said at least one fuel cell via said expander, and a secondary tank interposed between the main tank and said at least one fuel cell, being connected upstream to the main tank and being connected downstream to said at least one fuel cell via said expander.

2. An electricity production system according to claim 1, wherein said gaseous hydrogen generator contains hydrogen in solid form.

3. An electricity production system according to claim 2, including a filter that is situated immediately downstream from said generator and that is suitable for filtering the gases produced by said generator in order to pass only gaseous hydrogen H₂.

4. An electricity production system according to claim 1, wherein said at least one fuel cell is a high temperature PEMFC.

5. An electricity production system according to claim 2, wherein said at least one fuel cell is a high temperature PEMFC.

6. An electricity production system according to claim 1, including at least two fuel cells.
